(19) United States
(12) Patent Application Publication
(10) Pub. No.: US 2016/0335828 A1
(43) Pub. Date: Nov. 17, 2016

(54) OPTICAL SYSTEM AND METHOD OF JUDGING CATEGORY OF UNDER-TEST OBJECT BY USING SUCH OPTICAL SYSTEM

(71) Applicant: EVERREADY PRECISION IND. CORP., Kaohsiung City (TW)

(72) Inventors: Jyh-Long CHERN, Taipei City (TW); Chih-Ming YEN, New Taipei City (TW)

(21) Appl. No.: 15/142,921

(22) Filed: Apr. 29, 2016

(30) Foreign Application Priority Data
May 15, 2015 (TW) 104115678

(51) Int. Cl. G07D 7/20; G07D 7/12

(52) U.S. Cl. CPC G07D 7/2025; G07D 7/121

(57) ABSTRACT

An optical system and a method of judging a category of an under-test object are provided. The optical system includes a reflective structured light generation element and a sense judgement device. The reflective structured light generation element is installed on an under-test object. After the light beams from a light source are received by the reflective structured light generation element, a structured light is generated and reflected to an under-test surface. Consequently, a test pattern is shown on the under-test surface. The sense judgement device is used for sensing the test pattern on the under-test surface, and judging a category of the under-test object according to the sensed test pattern. The use of the structured light to judge the category of the under-test object can achieve the anti-counterfeiting efficacy.

### FIELD OF THE INVENTION

The present invention relates to an optical system, and more particularly to an optical system and a method of judging a category of an under-test object by using the optical system.

### BACKGROUND OF THE INVENTION

Recently, counterfeiting problems often happen in the product manufacturing and marketing processes. The term “counterfeiting” refers to the action of the manufacturer or dealer to imitate or use exclusive or well-known trademarks, product packings, decorations, names or other quality marks of other dealers with the intent to take advantage of competitive advantages. As known, the counterfeiting action may result in consumer confusion and market confusion and acquire illegitimate interests. That is, the counterfeiting action is largely harmful to the market competiveness.

For facilitating consumers to clearly recognize the authenticity of goods, many anti-counterfeit labels have been introduced into the markets. For example, the preset color effects or images of the laser anti-counterfeit labels are viewable in response to changes of viewing angles and light sources, or the miniature hidden texts are viewable through high-powered magnifying glasses. In addition, Taiwanese Patent No. I444899 discloses a passive RFID tag. The passive RFID tag not only provides anti-counterfeit efficacy but also transmits the product information. Consequently, the passive RFID tag can partially replace the barcode function. Moreover, Taiwanese Patent Publication No. 00324811 discloses a holographic anti-counterfeit label. By using a light diffraction theory, a hidden pattern that is invisible through an ordinary light source can be viewed when a laser beam is projected on the holographic anti-counterfeit label along a specified optical path.

Although many anti-counterfeiting techniques have been developed, there are still some drawbacks. For example, with the popularity and rapid propagation of information, the existing anti-counterfeiting techniques are imitated more easily and it is difficult to ensure their uniqueness. For preserving the interests of consumers and the reputations of manufacturers, it is important to develop an anti-counterfeiting technique with more diverseness or higher thresholds.

### SUMMARY OF THE INVENTION

For solving the drawbacks of the conventional technologies, the present invention provides an optical system and a method of judging a category of an under-test object by using a structured light.

In accordance with an aspect of the present invention, there is provided an optical system. The optical system includes a reflective structured light generation element and a sense judgement device. The reflective structured light generation element is installed on an under-test object. After light beams from a light source are received by the reflective structured light generation element, a structured light is generated and reflected to an under-test surface. When the structured light is projected on the under-test surface, a test pattern is shown on the under-test surface. The sense judgement device is used sensing the test pattern on the under-test surface, and judging a category of the under-test object according to the sensed test pattern.

In an embodiment, the optical system further includes the light source.

In an embodiment, the light source includes at least one of a laser diode, a light emitting diode and an organic light emitting diode, and/or the light source emits light beams in a thermal band.

In an embodiment, the light source emits light beams in a first wavelength range and/or light beams in a second wavelength range.

In an embodiment, the light beams in the first wavelength range are visible light beams, and the light beams in the second wavelength range are invisible light beams.

In an embodiment, the reflective structured light generation element includes plural working layers. The plural working layers receive the light beams in different wavelength bands and generate the structured light.

In an embodiment, the reflective structured light generation element is made of a heat-resistant material and/or an edible material.

In an embodiment, the reflective structured light generation element is made of phosphor materials, and locally or globally distributed on one of the plural working layers. The different layers or location may emit different bands of wavelength.

In an embodiment, the test pattern comprises a bar code pattern or a QR code pattern.

In an embodiment, the test pattern is variable in response to different viewing angles.

In an embodiment, the sense judgement device comprises a visible light sensing unit and/or an invisible light sensing unit.

In an embodiment, the sense judgement device includes a cloud image database and a judging unit, and the cloud image database contains plural image files. After the judging unit compares the test pattern with the plural image files, the judging unit judges the category of the under-test object.

In an embodiment, the category includes a real product category or a counterfeit product category.

In accordance with another aspect of the present invention, there is provided a method of judging a category of an under-test object. The method includes the following steps. Firstly, a reflective structured light generation element is installed on the under-test object. Then, light beams are projected on the reflective structured light generation element. After the light beams are received by the reflective structured light generation element, a structured light is generated and reflected to an under-test surface. When the structured light is projected on the under-test surface, a test pattern is shown on the under-test surface. Then, the test pattern on the under-test surface is sensed, and the category of the under-test object is judged according to the sensed test pattern.

In an embodiment, the method includes a step of providing a light source to project the light beams on the reflective structured light generation element.

In an embodiment, the light source includes at least one of a laser diode, a light emitting diode and an organic light emitting diode, and/or the light source emits light beams in a thermal band.

In an embodiment, the light source emits light beams in a first wavelength range and/or light beams in a second wavelength range.

In an embodiment, the light beams in the first wavelength range are visible light beams, and the light beams in the second wavelength range are invisible light beams.

In an embodiment, the reflective structured light generation element includes plural working layers. The plural working layers receive the light beams in different wavelength bands and generate the structured light.

In an embodiment, the test pattern comprises a bar code pattern or a QR code pattern.

In an embodiment, the method further includes a step of transmitting the sensed test pattern to a cloud image database. The cloud image database contains plural image files. After a judging unit compares the test pattern with the plural image files, the judging unit judges the category of the under-test object.

From the above descriptions, the present invention uses the structured light to judge the category of the under-test object in order to achieve the anti-counterfeiting efficacy. Moreover, the reflective structured light generation element can be specially designed according to the practical requirements. Consequently, the desired test pattern is shown on the under-test surface. That is, the test pattern has uniqueness, and it is difficult to imitate reflective structured light generation element.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of an optical system according to an embodiment of the present invention; and

FIG. 2 schematically illustrates a reflective structured light generation element of an optical system according to another embodiment of the present invention; and

FIG. 3 is a flowchart illustrating a method of judging a category of an under-test object according to an embodiment of the present invention.

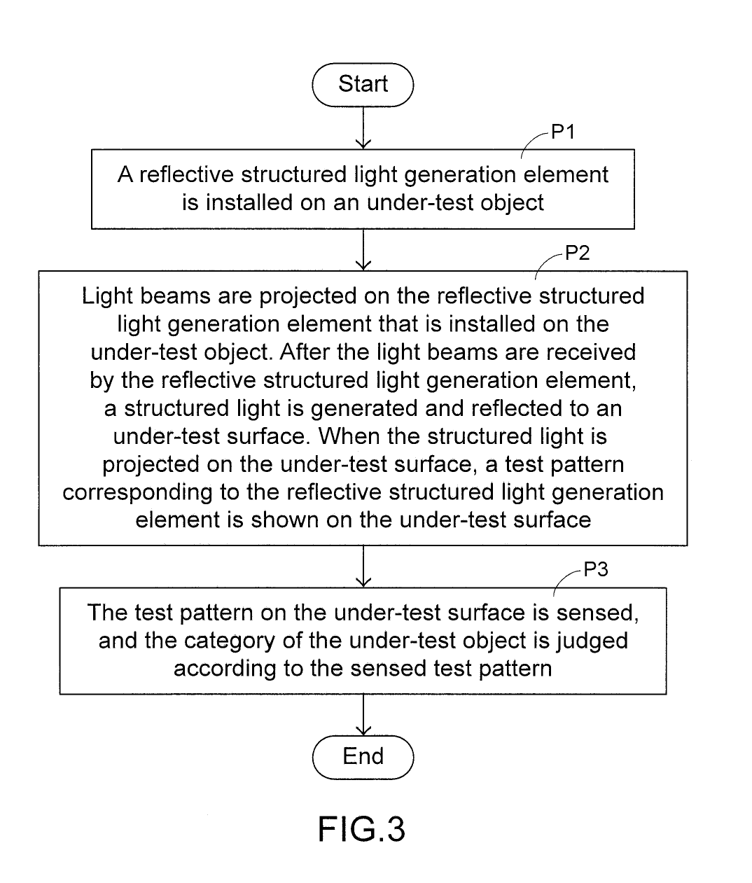

### DETAILED DESCRIPTION OF THE PREFERRED EMBODIMENT

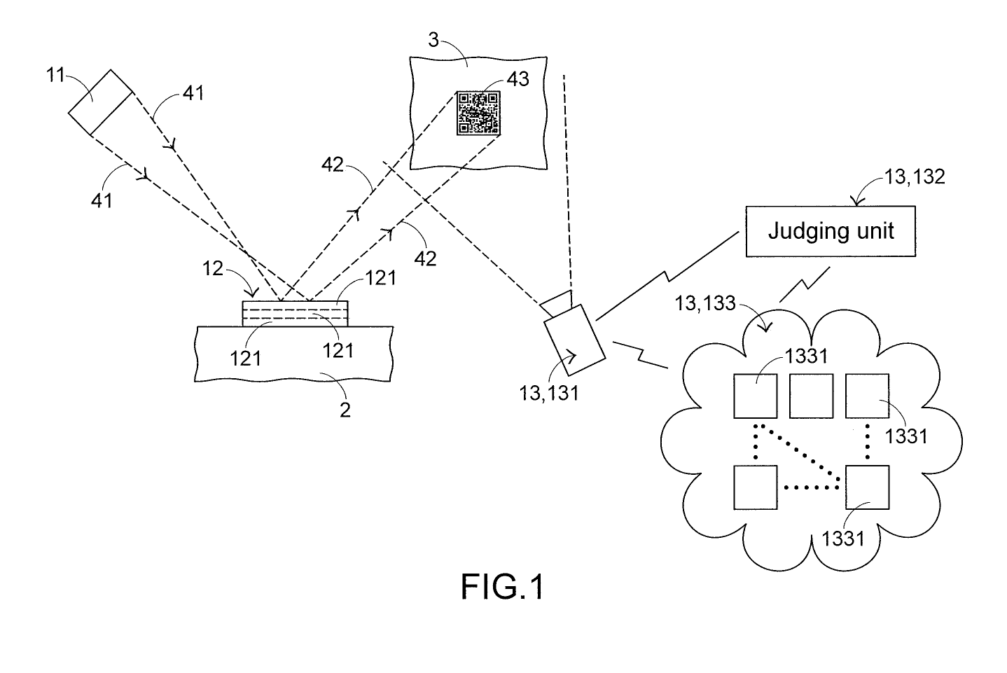

FIG. 1 schematically illustrates the architecture of an optical system according to an embodiment of the present invention. As shown in FIG. 1, the optical system 1 comprises a light source 11, a reflective structured light generation element 12 and a sense judgement device 13. The reflective structured light generation element 12 is installed (e.g., attached or printed) on an under-test object 2. The light source 11 provides light beams 41. The light beams 41 are projected on the reflective structured light generation element 12. After the light beams 41 from the light source 11 are projected on the reflective structured light generation element 12, a structure light 42 is generated and reflected to an under-test surface 3. Consequently, a test pattern 43 corresponding to the reflective structured light generation element 12 is shown on the under-test surface 3. The sense judgement device 13 is used for sensing the test pattern 43 on the under-test surface 3 and judging the category of the under-test object 2 according to the sensed test pattern 43.

In an embodiment, the light source 11 comprises a laser diode (LD), a light emitting diode (LED), an organic light emitting diode (OLED), and/or or any other comparable semiconductor-category light-emitting element similar to the laser diode, the light emitting diode or the organic light emitting diode. The light beams 41 from the light source 11 include the light beams in a first wavelength range (e.g., visible light beams) and/or the light beams in a second wavelength range (e.g., invisible light beams or light beams in a thermal band).

In an embodiment, the reflective structured light generation element 12 is a reflective diffractive optical element (DOE). The reflective structured light generation element 12 comprises plural working layers 121. The plural working layers 121 are used for receiving the light beams in different wavelength bands and generating the structured light 42 to the under-test surface 3. When the structured light 42 is projected on the under-test surface 3, the test pattern 43 shown on the under-test surface 3 corresponds to the structure of the reflective structured light generation element 12. The structure of the reflective structured light generation element 12 can be specially designed by those skilled in the art according to the practical requirements. Consequently, the desired test pattern 43 is shown on the under-test surface 3. For example, according to the structure of the reflective structured light generation element 12, the test pattern shown on the under-test surface 3 is a bar code pattern or a QR code pattern, or the test pattern is variable in response to different viewing angles. The method of designing the structure of the reflective structured light generation element 12 to show the desired test pattern 43 on the under-test surface 3 is well known to those skilled in the art, and is not redundantly described herein.

In this embodiment, the sense judgement device 13 comprises a sensing unit 131, a judging unit 132 and a cloud image database 133. The cloud image database 133 contains plural image files 1331. An example of the sensing unit 131 includes but is not limited to a charge couple device (CCD) or a complementary metal-oxide-semiconductor (CMOS). Moreover, according to the type of the light source, the sensing unit 131 is a visible light sensing unit and/or an invisible light sensing unit. The sensing unit 131 is used for sensing the test pattern 43 that is shown on the under-test surface 3. After the test pattern 43 on the under-test surface 3 is captured by the sensing unit 131, the captured test pattern 43 is transmitted to the judging unit 132 in a wired transmission manner or a wireless transmission manner. Then, the judging unit 132 compares the captured test pattern 43 with the plural image files 1331 of the back-end cloud image database 133. According to the comparing result, the judging unit 132 judges the category of the under-test object 2.

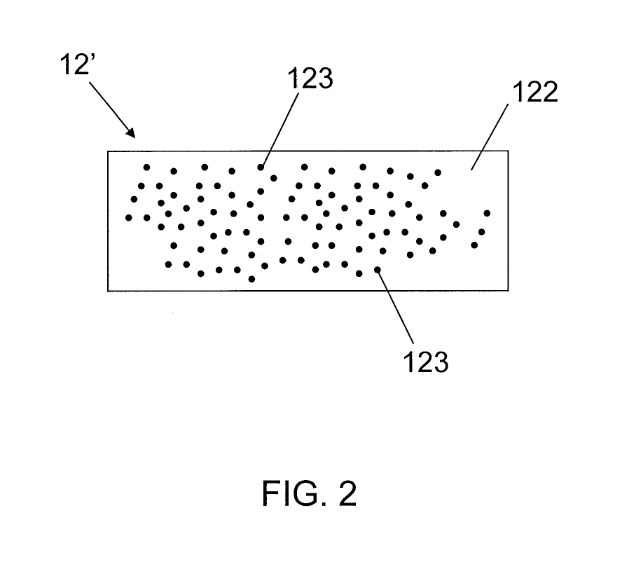

In another embodiment, the reflective structured light generation element 12′ of the optical system 1 further includes a plurality of phosphor particles 123, the phosphor particles 123 are locally or globally distributed on a substrate 122 (or several working layers), as shown in FIG. 2. The substrate 122 (or working layers) receives the light beams 41 in different wavelength bands and therefore generates the structured light additionally with phosphor-generated light emitting to the sense judgement device 13 for a further identification on the under-test object 2.

The applications of the optical system 1 will be illustrated as follows. For example, the optical system 1 can be used to recognize the authenticity of Chinese mitten crabs. As known, Chinese mitten crabs have tender meat, delicious taste, nutritious ingredients and other characteristics, and thus Chinese mitten crabs are favored by many gourmands in in autumn and winter. Consequently, the prices of the Chinese mitten crabs are artificially forced up. In some situations, unscrupulous dealers often falsely claim unidentified crabs to be the Chinese mitten crabs or use smuggled crabs without quarantine or drug tests in order to acquire a great amount of profits. For protecting the interests and health of consumers, it is very important to provide a method of recognizing the authenticity of Chinese mitten crabs. Consequently, the consumers can clearly recognize whether the Chinese mitten crabs to be purchased are real products or counterfeit products.

In particular, the competent authority of administrating Chinese mitten crabs may attach specially-designed reflective structured light generation element 12 on the certificated Chinese mitten crabs. A seller or a buyer may allow the light beams 41 from the light source 11 to be projected on the specially-designed reflective structured light generation element 12 and reflected to the under-test surface 3. Consequently, a specified test pattern 43 is shown on the under-test surface 3. Then, the seller or the buyer uses the sensing unit 131 to capture the test pattern 43 on the under-test surface 3. If the captured test pattern 43 complies with one of the plural image files 1331 in the cloud image database 133 (i.e., the image file of the certificated Chinese mitten crab), the seller or the buyer can confidently determine that it is the certificated crabs. Since the under-test object 2 is food and the reflective structured light generation element 12 is attached on the under-test object 2, the reflective structured light generation element 12 is preferably made of an edible material, a heat-resistant material and/or any other material that is harmless to human bodies.

The optical system 1 is not restricted to recognize the authenticity of Chinese mitten crabs. In another embodiment, the optical system 1 is used to recognize the authenticity of natural jades or natural precious stones. Moreover, the optical system 1 is not restricted to recognize the authenticity of the under-test object 2. In another embodiment, the optical system 1 is used to judge the production time, the production place or any other logistics category of the under-test object 2. For example, the optical system 1 can be used to mark information on an engine or a tire of a vehicle. The above application examples are presented herein for purpose of illustration and description only. It is noted that numerous modifications and alterations may be made while retaining the teachings of the invention. For example, in another embodiment, the reflective structured light generation element 12 is a single-layered structure that only receives the light beams in a single wavelength band. In a further embodiment, the sensing unit 131, the judging unit 132 and the cloud image database 133 of the sense judgement device 13 are integrated into a single instrument.

The present invention further provides a method of judging a category of an under-test object. FIG. 2 is a flowchart illustrating a method of judging a category of an under-test object according to an embodiment of the present invention. In a step P1, a reflective structured light generation element 12 is installed on an under-test object 2. In a step P2, light beams 41 are projected on the reflective structured light generation element 12 that is installed on the under-test object 2. After the light beams 41 are received by the reflective structured light generation element 12, a structured light 42 is generated and reflected to an under-test surface 3. When the structured light 42 is projected on the under-test surface, a test pattern 43 corresponding to the reflective structured light generation element 12 is shown on the under-test surface 43. In a step P3, the test pattern 43 on the under-test surface 3 is sensed, and the category of the under-test object 2 is judged according to the sensed test pattern 43.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An optical system, comprising:
a reflective structured light generation element installed on an under-test object, wherein after light beams from a light source are received by the reflective structured light generation element, a structured light is generated and reflected to an under-test surface, wherein when the structured light is projected on the under-test surface, a test pattern is shown on the under-test surface; and
a sense judgement device sensing the test pattern on the under-test surface, and judging a category of the under-test object according to the sensed test pattern.

2. The optical system according to claim 1, wherein the optical system further comprises the light source.

3. The optical system according to claim 2, wherein the light source comprises at least one of a laser diode, a light emitting diode and an organic light emitting diode, and/or the light source emits light beams in a thermal band.

4. The optical system according to claim 2, wherein the light source emits light beams in a first wavelength range and/or light beams in a second wavelength range.

5. The optical system according to claim 4, wherein the light beams in the first wavelength range are visible light beams, and the light beams in the second wavelength range are invisible light beams.

6. The optical system according to claim 1, wherein the reflective structured light generation element comprises plural working layers, wherein the plural working layers receive the light beams in different wavelength bands and generate the structured light.

7. The optical system according to claim 1, wherein the reflective structured light generation element comprises phosphor particles locally or globally distributed.

8. The optical system according to claim 1, wherein the reflective structured light generation element is made of a heat-resistant material and/or an edible material.

9. The optical system according to claim 1, wherein the test pattern comprises a bar code pattern or a QR code pattern.

10. The optical system according to claim 1, wherein the test pattern is variable in response to different viewing angles.

11. The optical system according to claim 1, wherein the sense judgement device comprises a visible light sensing unit and/or an invisible light sensing unit.

12. The optical system according to claim 1, wherein the sense judgement device comprises a cloud image database and a judging unit, and the cloud image database contains plural image files, wherein after the judging unit compares the test pattern with the plural image files, the judging unit judges the category of the under-test object.

13. The optical system according to claim 1, wherein the category includes a real product category or a counterfeit product category.

14. A method of judging a category of an under-test object, the method comprising steps of:
installing a reflective structured light generation element on the under-test object;
projecting light beams on the reflective structured light generation element, wherein after the light beams are received by the reflective structured light generation element, a structured light is generated and reflected to an under-test surface, wherein when the structured light is projected on the under-test surface, a test pattern is shown on the under-test surface; and
sensing the test pattern on the under-test surface, and judging the category of the under-test object according to the sensed test pattern.

15. The method according to claim 14, further comprising a step of providing a light source to project the light beams on the reflective structured light generation element.

16. The method according to claim 15, wherein the light source comprises at least one of a laser diode, a light emitting diode and an organic light emitting diode, and/or the light source emits light beams in a thermal band.

17. The method according to claim 15, wherein the light source emits light beams in a first wavelength range and/or light beams in a second wavelength range.

18. The method according to claim 17, wherein the light beams in the first wavelength range are visible light beams, and the light beams in the second wavelength range are invisible light beams.

19. The method according to claim 14, wherein the reflective structured light generation element comprises plural working layers, wherein the plural working layers receive the light beams in different wavelength bands and generate the structured light.

20. The method according to claim 14, wherein the reflective structured light generation element comprises phosphor particles distributed locally or globally.

21. The method according to claim 14, wherein the test pattern comprises a bar code pattern or a QR code pattern.

22. The method according to claim 14, further comprising a step of transmitting the sensed test pattern to a cloud image database, wherein the cloud image database contains plural image files, wherein after a judging unit compares the test pattern with the plural image files, the judging unit judges the category of the under-test object.
